(19) United States
(12) Patent Application Publication
(10) Pub. No.: US 2022/0275881 A1
(43) Pub. Date: Sep. 1, 2022

(54) HYDRAULIC ISOLATION VALVE

(71) Applicant: Poseidon Deepwater Solutions LLC, Katy, TX (US)

(72) Inventors: Michael James Mahaney, Richmond, TX (US); Christopher Glenn Phillips, Pattison, TX (US)

(21) Appl. No.: 17/680,107

(22) Filed: Feb. 24, 2022

Related U.S. Application Data
(60) Provisional application No. 63/154,148, filed on Feb. 26, 2021.

(51) Int. Cl. F16K 31/50; F16K 31/60

(52) U.S. Cl. CPC F16K 31/508; F16K 31/60; E21B 34/06

(57) ABSTRACT

A hydraulic isolation valve having a body comprising a first fluid port configured to allow pressure to enter the body, a second fluid port configured to allow the pressure that entered the body to exit the body; a central bore configured to intersect the first fluid port and the second fluid port and a sealing element axially disposed within the central bore.

### CROSS-REFERENCE TO RELATED APPLICATIONS

The present application claims priority to U.S. Provisional Application 63/154,148, filed Feb. 26, 2021, the entirety of which is incorporated by reference.

### FIELD OF DISCLOSURE

Aspects of the disclosure relate to valve technology. More specifically, aspects of the disclosure relate to valves used in hydraulic systems to temporarily allow or disallow fluid flow. These valves are commonly used in pumps and test equipment, circuits, etc., used to pressure test or instrument hydraulic systems used in hydrocarbon recovery and processing facilities.

### BACKGROUND

Hydraulic systems are comprised of a pressure source, interconnection of tubing/hoses, and end use devices (i.e., cylinder, motors, sensor, pressure gauge). There are times when the fluid should be trapped or isolated within a portion of the system to allow detection of leaks, verify integrity of the plumbing, or otherwise restrict fluid movement. In some cases, the fluid must be vented at a slow rate to avoid shock to the system or components. Conventional systems have a poor track record of avoiding shocks to systems and components and there is a significant need to prevent such shocks from occurring.

Conventional apparatus and methods achieve the temporary fluid movement into or out of a system by an isolation valve. The isolation valve is typically a “needle” type construction. In these types of construction, there is a central conical shaped element which is forced into a mating conical surface. These conventional apparatus block the fluid flow by a mechanically engaged metal to metal seal. In some instances, the seal is complemented with an elastomer. The engagement allows a wide range of partial engagement which also provides for variable flow area through the valve. These types of configurations allow the user to have a fully open or partially open valve within the circuit depending upon the needs of the specific test or activity.

In these types of construction, isolation is achieved by (i.e, “needle” valve, the central element(s)) axial movement to engage the seal seat by means of a T-handle and a screw. In some cases, the T-handle directly affects the sealing element, and in other cases, the handle is separated by means of sliding bearings, etc. The T-handle stem is also sealed along its length to prevent process fluids from escaping around the shaft.

Typically, an adjustment method is used to axially compress the seal, which is comprised of several rings of elastomer, to achieve the desired combination of seal and extra torque on the shaft/handle. The amount of compression used increases the sealing capability but also increases the amount of torque required to rotate the T-handle. There is a possibility that the user may over-torque the packings and render the valve damaged or non-useful.

In these applications, the operator can easily apply too much torque. This is especially true if an additional form of leverage is used on the T-handle. The central conical element can, in some cases, be over-compressed by user input. When this occurs, the seat is damaged and can no longer function as it was when new. The next time the valve is needed to be closed, it will require at least as much torque to close it and seal off the fluid. Eventually, the valve seat has been damaged beyond use. When replacing this central sealing element, there are many variations and each one is unique to the valve, (i.e, not universal). This leads to uncertainty in stocking of spare parts, sourcing replacements, etc.

There is also a possibility that the amount of torque applied, either to overcome drag from pressure and seal compression or seating force, or a combination of both, will exceed the handles connection strength to the central stem. In many instances, this design involves using a set-screw within the handle which contacts a flat portion of the stem. In other cases, the design may incorporate a through-hole on the stem. In most designs, this is a weak point of the valve. In addition to the connection becoming damaged, portions of the valve may become loose due to vibration and use and potentially fall off. This causes a poor user experience as there is no other way to operate the valve resulting in a potentially dangerous situation.

The valve 100 in FIG. 1 is used as an example of many of the issues which face the current technology (PRIOR ART) in isolation valves. The valve has a body 101 which contains the two ports, inlet 102 and outlet 103. These are also intersected by a central bore 104 which contains a sealing element 105. The sealing element 105 is forced into a sealing surface or edge feature 106 contained in the body 101. This sealing action is encouraged by rotating a handle 108 which utilizes screw threads 113 to convert rotation into linear motion. A few seals 109 are contained which prevent pressure 107 from escaping. There are some elements 110 which accompany the seals to encourage proper operation. A method of retaining 111 the handle 108 also provides threads 113 to operate the valve. Various methods of connecting external pressure sources to the valve body 101 are available, and in this example a deforming metal seal 112 is utilized.

The issue with the current isolation valve 100 can be explained by referencing the two items, shaft sealing 109 and actuator thread system 113, along with the orientation of items 105 and 106. The current isolation valve 100 has an imbalance of forces due to internal pressure 107 causing the valve to attempt to open, or move the sealing element 105 away from the sealing feature 106. In this respect, not only must the screw threads 113 overcome this force, but also must provide sufficient force to create a seal at the interface. This force balance is dependent on the internal pressure value. There is no indication of the additional amount of force to the operator, and this value changes with pressure 107 in the valve 100. Thus it is very likely that there is either too much or too little force on the stem seal 106 at any given point in time. Most operators use too much torque on the handle 108 and destroy the interface 106 or the sealing element 105. There is also no limiter on the threads 113 to prevent an operator from applying too much axial force on the sealing element and interface

Based upon current offerings of isolation valves, there is a need in the market for one which provides an improved operation in many areas.

There is a further need to provide a configuration that does not allow the user to over compress the sealing element.

There is a further need to improve conventional hydraulic isolation valve handle connections.

There is a further need to provide a sealing element that is able to be changed by field operations personnel that alleviates the need for numerous components and different sizes.

There is a further need to provide a more economical method for repair and maintenance operations.

### SUMMARY

So that the manner in which the above recited features of the present disclosure can be understood in detail, a more particular description of the disclosure, briefly summarized below, may be had by reference to embodiments, some of which are illustrated in the drawings. It is to be noted that the drawings illustrate only typical embodiments of this disclosure and are therefore not to be considered limiting of its scope, for the disclosure may admit to other equally effective embodiments without specific recitation. Accordingly, the following summary provides just a few aspects of the description and should not be used to limit the described embodiments to a single concept.

In one example embodiment of the disclosure, a hydraulic isolation valve is disclosed. The valve may comprise a body having a first fluid port for fluid to enter the body, a second fluid port for fluid to exit the body and a bore configured to extend between the first fluid port and the second fluid port, wherein the bore is further configured with a top bore. The valve may also be configured with a handle positioned within the top bore and a sealing element configured to interface with the first fluid port and the second fluid port. The valve may also be configured with a ball configured to interface with a portion of the handle and the sealing element and a sealing interface positioned between the sealing element and the body.

In one example embodiment, a method of opening a hydraulic isolation valve is disclosed. The method may comprise rotating a handle of a hydraulic isolation valve. The method may also comprise converting a rotation of a stem of the handle into a linear motion of a stem. The method may also comprise pushing a ball with the stem such that the ball interfaces with a sealing element and forces the sealing element away from a sealing surface within the valve body.

### BRIEF DESCRIPTION OF DRAWINGS

In the following detailed description of an exemplary embodiment, reference is made to the accompanying drawings, which form a part hereof and in which are shown by way of illustration examples of an exemplary embodiment with which the invention may be practiced. In the drawings and descriptions, like or corresponding parts are marked throughout the specification and drawings with the same reference numerals. The drawings are not necessarily to scale. Certain features of the invention may be shown exaggerated in scale or in somewhat symbolic or schematic form and some details of conventional elements may not be shown in the interest of clarity and conciseness. Referring to the drawings:

FIG. 1 is a side sectional view of a typical prior art isolation valve prior art.

FIG. 2 is a side sectional view of an improved isolation valve.

FIG. 3 is a detailed side sectional view of the improved isolation valve.

FIG. 4A is a detailed side sectional view of an improved isolation valve.

FIG. 4B is a detailed side sectional view of an improved isolation valve with an alternate construction method.

FIG. 5 is a method of opening a hydraulic isolation valve in accordance with one example embodiment of the disclosure.

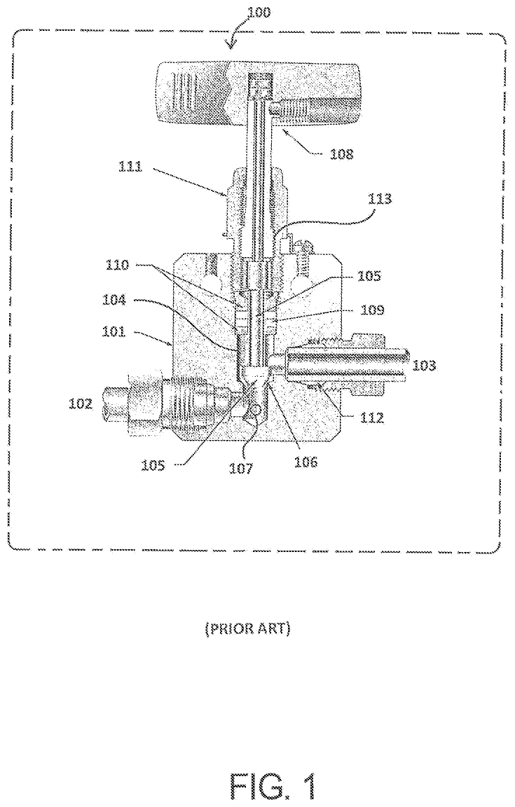

To facilitate understanding, identical reference numerals have been used, where possible, to designate identical elements that are common to the figures (“FIGS.”). It is contemplated that elements disclosed in one embodiment may be beneficially utilized on other embodiments without specific recitation.

### DETAILED DESCRIPTION

In the following, reference is made to embodiments of the disclosure. It should be understood, however, that the disclosure is not limited to specific described embodiments. Instead, any combination of the following features and elements, whether related to different embodiments or not, is contemplated to implement and practice the disclosure. Furthermore, although embodiments of the disclosure may achieve advantages over other possible solutions and/or over the prior art, whether or not a particular advantage is achieved by a given embodiment is not limiting of the disclosure. Thus, the following aspects, features, embodiments and advantages are merely illustrative and are not considered elements or limitations of the claims except where explicitly recited in a claim. Likewise, reference to “the disclosure” shall not be construed as a generalization of inventive subject matter disclosed herein and should not be considered to be an element or limitation of the claims except where explicitly recited in a claim.

Although the terms first, second, third, etc., may be used herein to describe various elements, components, regions, layers and/or sections, these elements, components, regions, layers and/or sections should not be limited by these terms. These terms may be only used to distinguish one element, component, region, layer or section from another element, component, region, layer or section. Terms such as “first”, “second” and other numerical terms, when used herein, do not imply a sequence or order unless clearly indicated by the context. Thus, a first element, component, region, layer or section discussed herein could be termed a second element, component, region, layer or section without departing from the teachings of the example embodiments.

When an element or layer is referred to as being “on,” “engaged to,” “connected to,” or “coupled to” another element or layer, it may be directly on, engaged, connected, coupled to the other element or layer, or interleaving elements or layers may be present. In contrast, when an element is referred to as being “directly on,” “directly engaged to,” “directly connected to,” or “directly coupled to” another element or layer, there may be no interleaving elements or layers present. Other words used to describe the relationship between elements should be interpreted in a like fashion. As used herein, the term “and/or” includes any and all combinations of one or more of the associated listed terms.

Some embodiments will now be described with reference to the figures. Like elements in the various figures will be referenced with like numbers for consistency. In the following description, numerous details are set forth to provide an understanding of various embodiments and/or features. It will be understood, however, by those skilled in the art, that some embodiments may be practiced without many of these details, and that numerous variations or modifications from the described embodiments are possible. As used herein, the terms “above” and “below”, “up” and “down”, “upper” and “lower”, “upwardly” and “downwardly”, and other like terms indicating relative positions above or below a given point are used in this description to more clearly describe certain embodiments.

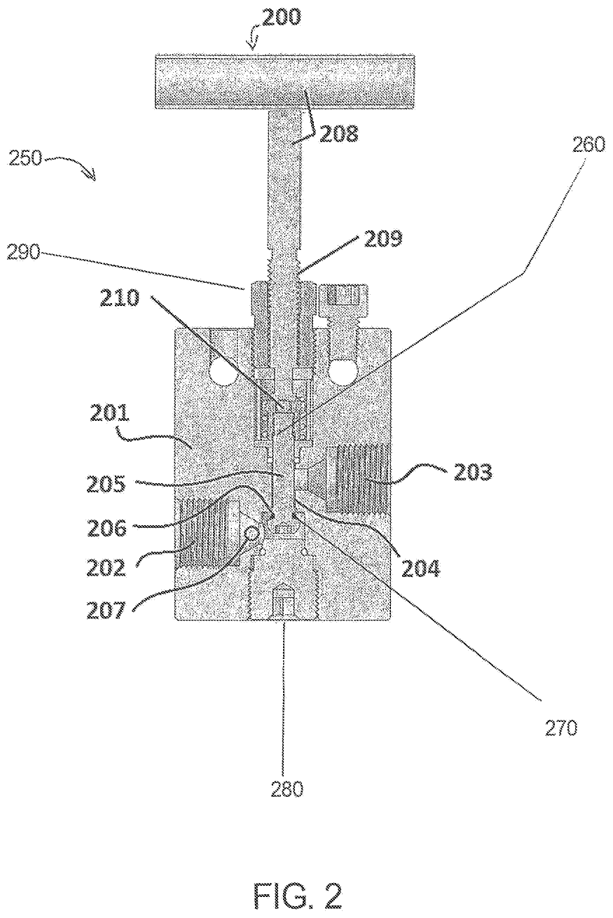

In one embodiment of the disclosure, a hydraulic valve 200 is disclosed. Referring to FIG. 2, a valve body 201 is arranged with an inlet port 202 and an outlet port 203. These fluid ports 202, 203 intersect a bore 204, wherein the bore 204 extends between the first fluid port (the inlet port 202) and the second fluid port (the outlet port 203). In the illustrated embodiment, the bore 204 is centralized within the valve body 201. As will be understood, other configurations, such as an off-center placement may be possible, therefore the centralized positioning of the bore 204 should not be considered limiting. The bore 204 is equipped with a sealing element 205 which seals on a body portion 206 in response to pressure 207. In a closed position, fluid pressure 207 is prevented from transferring from the inlet port 202 to the outlet port 203. In embodiments, the inlet port 202 may be described as the first fluid port and the outlet port 203 as the second fluid port. A top bore 250 may also extend from the bore 204 such that an apparatus may be inserted into the bore 204 and extend down into the bore 204. The inlet port 202 and the outlet port 203 may be configured with threading to allow for easy connection of piping and equipment. The inlet port 202 and the outlet port 203 may be configured with a conical portion, as illustrated, for forming a flow regime within the valve body 201.

The method of “opening” the valve 200 requires moving the sealing element 205 away from the sealing surface within the body portion 206. The method of providing this motion is provided in this example by rotating a handle 208 which is equipped with threads 209. These threads 209 convert rotation into linear motion. In one example embodiment, the method provides for pushing the sealing element, not pulling. The pushing is accomplished through a ball 210 for reduced torque. A stop 280 may be provided to limit the overall travel of the stem of the handle 208 so that excessive opening distances are not achieved. A bushing 290 may be inserted within the top bore to guide the stem of the handle 208 down into the body 201 of the valve 200. The bushing 290 may be configured with threading the interfaces with threading on the stem of the handle 208.

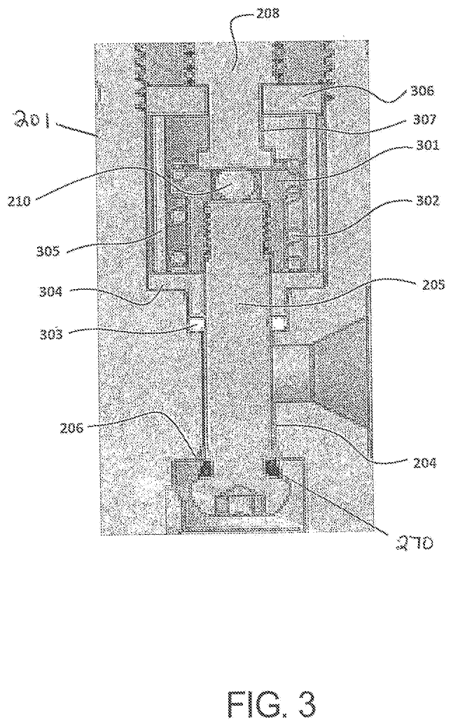

The details of the sealing element 205 and a method of operation are one aspect of the improved operation of the valve 200. In FIG. 3 these details are visible. The sealing element 205 is positioned in the bore 204 and pushed downward by rotating the handle 208. This action forces the stem 260 away from the sealing surface 270. The sealing element 205 is returned to position through two forces, namely spring force and pressure:

In the case of spring force, a physical spring 302 is acting on a retainer 301 which is affixed to the sealing element 205. In this embodiment threads are used, as this feature is existing on the sealing element 205.

In the case of pressure 207, the fluid within the valve acts on the sealing element 205 by a seal 303. This pressure forces the sealing element 205 “up” (orientated within the image) and would tend to close the valve. The seal 303 is retained by several items 304 and 305 which are retained in the valve body 201 rigidly.

There is a feature within the improved valve body 201 which limits the transmission of force from the handle into the aforementioned sealing element 205. The shaft has a reduced section 307 which presents an area of limited travel within a top retainer 306. This prevents the handle from travelling beyond this limits of the section 307. This thereby prevents any additional force from being imparted onto the sealing element 205 which can result in damage of the body portion (sealing interface) 206.

One aspect of the current disclosure provides a sealing element 205 which is only acted upon by the fluid pressure 207 and is always attempting to “close”. To this end, the hydraulic isolation valve is provided in a naturally sealed configuration. In this embodiment, the state is directly opposite of the prior art configurations that allow for a naturally sealed configuration. Thus, the basic arrangement of components allow for a more secure sealing of the hydraulic isolation valve compared to conventional apparatus. Thus, when changing the state of the valve from closed to open, the operator only is required to apply enough force to overcome this closing force and disrupt the body portion (sealing interface) 206. This provides significant advantage compared to conventional apparatus where significant torque must be applied, sometimes to the detriment of the valve. When changing the state of the valve from open to closed, the operator is only required to allow the sealing element 205 to close, being acted upon by pressure. This self-closing action allows the valve to only operate against fluid pressure acting on the screw threads, and negates the required additional force to impart a seal. Thus, the operating torque is significantly lower than existing valves. This is a significant advantage over conventional apparatus.

In embodiments provided in the disclosure, the conversion of rotary motion to axial motion is limited by features within the valve, preventing damage to the valve components. This configurations prevents the operator from applying too great of force and motion into the sealing element. As well the fluid pressure only applies the proportional amount of closing force to the sealing interface 206 based on its only value. Thus, the sealing element is always experiencing the appropriate amount of contact force at its interface. This extends the life of the sealing element dramatically.

Another improvement is the handle and stem system. The current valve requires a packing nut 111 to be tightened and holds packing 109 around the central shaft 105. This is critical as it can add some torque to the handle 108. A method is required to then prevent this from rotating. The current invention negates this need as it provides a unique sealing system around the shaft which is trapped and designed to not rotate or translate as far. Thus the seal is a much longer life expectancy and easier to maintain.

The final improvement over the typical current valve technology 100 is the method of attaching the handle to the stem. This is an area of much pain and suffering in the industry. The handles become loose for two reasons; they use a fastener which can back out, and, the torque applied to the handle is higher than the fastener system can manage. The torque is exceeded due to the operator attempting to stop the valve from leaking. This torque value, which is based on pressure is not well understood or any feedback given accordingly and is exceedingly high in most cases. This leads to very short service life of the valve due to the handle malfunctioning. In the current invention the handle is welded or affixed without fasteners. In the event that the handle was joined from multiple pieces, the torque imparted to it would be significantly lower than that in existing valves as it opens and closes with lower torque. Therefore it is anticipated that the handle will last longer. A design feature of the existing valve is that the packing must be fed onto the valve stem from the top, or above the sealing element. In the case of the current invention, the handle has no seals, and doesn't need to pass any seals over it, which allows the cross bar to be one piece with the stem. This negates the use of fasteners.

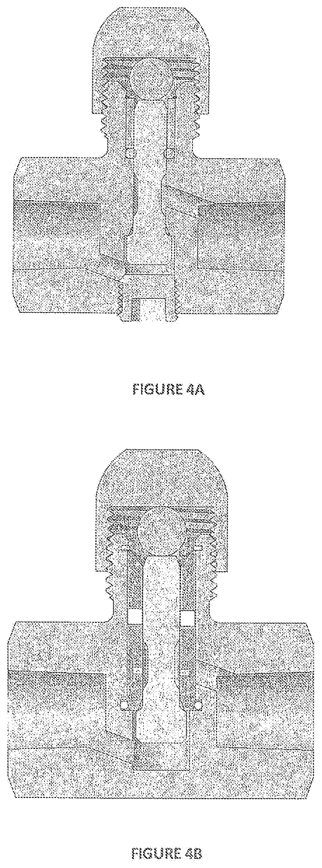

It can be appreciated that this technology can be adapted into alternate packaging methods which represent the same important features and operation. FIGS. 4A and 4B present a version of the isolation valve. In this manner a body is presented with both inlet and outlet ports. There is a central bore which is (in FIG. 4A) intersecting the body in two places, one which must be plugged. This plug is for maintenance purposes and assembly. However, in FIG. 4B, this bore can be blind, and not intersect the exterior in two places. FIG. 4B requires more seals to trap/contain pressure and a few more rings or sleeves. Both are actuated by a “handle” which is nothing more than an inverted bucket with threads on the inside and gripping features on the outer diameter. In some cases, wrench flats can be made, and in others a knurled surface for interface with fingers and hands to provide grip. In another example, a “T-Handle” shaped paddle or knob can be fashioned with the same internal bore. A ball is shown to reduce friction and torque when operating, however this is but one possible configuration.

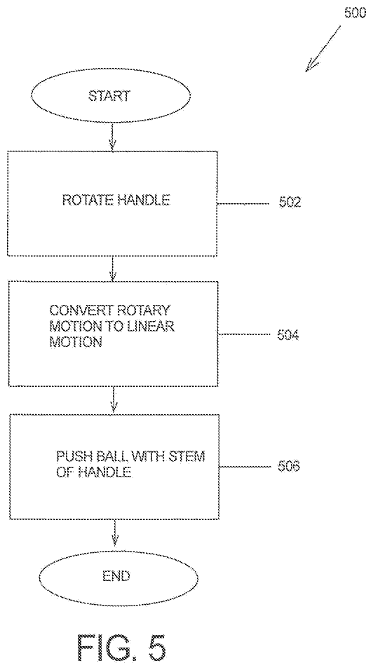

Referring to FIG. 5, an example method 500 of opening a valve described in FIG. 2 is illustrated. The method 500, may entail rotating a handle of a hydraulic isolation valve at 502. The method may continue at 504, wherein a rotation of a stem of the handle is converted into linear motion. This rotation may be converted through use of a threading. The method may further continue at 506 by pushing a ball with the stem of the handle such that the ball interfaces with a sealing element and forces the sealing element away from a sealing surface within the valve body. As will be understood, closing of the valve may be a reverse of the above by rotating the handle in the opposite direction, however the valve may be biased such that pressure within the valve body closes the valve. In another example embodiment, the valve may be closed through pressure sealing the sealing element back to the sealing surface within the valve body.

Aspects of the disclosure provide an improved operation in many areas compared to the conventional apparatus.

Aspects of the disclosure provide a configuration that does not allow the user to over compress the sealing element.

Aspects of the disclosure provide an improvement over conventional hydraulic isolation valve handle connections.

Aspects of the disclosure provide a sealing element that is able to be changed by field operations personnel that alleviates the need for numerous components and different sizes.

Aspects of the disclosure provide a more economical method for repair and maintenance operations.

In one example embodiment of the disclosure, a hydraulic isolation valve is disclosed. The valve may comprise a body having a first fluid port for fluid to enter the body, a second fluid port for fluid to exit the body and a bore configured to extend between the first fluid port and the second fluid port, wherein the bore is further configured with a top bore. The valve may also be configured with a handle positioned within the top bore and a sealing element configured to interface with the first fluid port and the second fluid port. The valve may also be configured with a ball configured to interface with a portion of the handle and the sealing element and a sealing interface positioned between the sealing element and the body.

In another example, the hydraulic isolation valve may be configured wherein the handle is a T shaped handle.

In another example embodiment of the disclosure, the hydraulic isolation valve may further comprise a bushing placed within the top bore, the bushing having an inside surface that has a threading and wherein the handle is configured with threads on an exterior such that the threading on the inside surface of the bushing mates with the handle threading.

In another example embodiment of the disclosure, the hydraulic isolation valve may be configured wherein the first fluid port contains a threading.

In another example embodiment of the disclosure, the hydraulic isolation valve may be configured wherein the second fluid port contains a threading.

In another example embodiment of the disclosure, the hydraulic isolation valve may be configured wherein the first fluid port and the second fluid port are not aligned in a straight line.

In another example embodiment of the disclosure, the hydraulic isolation valve may be configured wherein at least one of the first fluid port and the second fluid port have a conical inside surface.

In another example embodiment of the disclosure, the hydraulic isolation valve may further comprise a stop configured to interface with the sealing element to prevent axial travel of the sealing element further than a defined length.

In one example embodiment, a method of opening a hydraulic isolation valve is disclosed. The method may comprise rotating a handle of a hydraulic isolation valve. The method may also comprise converting a rotation of a stem of the handle into a linear motion of a stem. The method may also comprise pushing a ball with the stem such that the ball interfaces with a sealing element and forces the sealing element away from a sealing surface within the valve body.

In one example embodiment, the method may be performed wherein the handle is a T handle.

In one example embodiment, the method may be performed wherein the converting is through use of a threading.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may be varied in many ways. Such variations are not to be regarded as a departure from the disclosure, and all such modifications are intended to be included within the scope of the disclosure.

While embodiments have been described herein, those skilled in the art, having benefit of this disclosure, will appreciate that other embodiments are envisioned that do not depart from the inventive scope. Accordingly, the scope of the present claims or any subsequent claims shall not be unduly limited by the description of the embodiments described herein.

What is claimed is:

1. A hydraulic isolation valve, comprising:
a body having
a first fluid port for fluid to enter the body;
a second fluid port for fluid to exit the body;
a bore configured to extend between the first fluid port and the second fluid port, wherein the bore is further configured with a top bore;
a handle positioned within the top bore;
a sealing element configured to interface with the first fluid port and the second fluid port;
a ball configured to interface with a portion of the handle and the sealing element; and
a sealing interface positioned between the sealing element and the body.

2. The hydraulic isolation valve according to claim 1, wherein the handle is a T shaped handle.

3. The hydraulic isolation valve according to claim 2, further comprising:
a bushing placed within the top bore, the bushing having an inside surface that has a threading and wherein the handle is configured with threads on an exterior such that the threading on the inside surface of the bushing mates with the handle threading.

4. The hydraulic isolation valve according to claim 1, wherein the first fluid port contains a threading.

5. The hydraulic isolation valve according to claim 1, wherein the second fluid port contains a threading.

6. The hydraulic isolation valve according to claim 1, wherein the first fluid port and the second fluid port are not aligned in a straight line.

7. The hydraulic isolation valve according to claim 1, wherein at least one of the first fluid port and the second fluid port have a conical inside surface.

8. The hydraulic isolation valve according to claim 1, further comprising:
a stop configured to interface with the sealing element to prevent axial travel of the sealing element further than a defined length.

9. A method of opening a hydraulic isolation valve, comprising:
rotating a handle of a hydraulic isolation valve;
converting a rotation of a stem of the handle into a linear motion of a stem; and
pushing a ball with the stem such that the ball interfaces with a sealing element and forces the sealing element away from a sealing surface within the valve body.

10. The method according to claim 9, wherein the handle is a T handle.

11. The method according to claim 9, wherein the converting is through use of a threading.
